(19) United States
(12) Patent Application Publication
(10) Pub. No.: US 2017/0233857 A1
(43) Pub. Date: Aug. 17, 2017

(54) Al-Mg-Zn Alloy With Scandium For The Integral Construction Of ALM Structures

(71) Applicant: Airbus Defence and Space GmbH, Taufkirchen (DE)

(72) Inventor: Blanka Lenczowski, Neubiberg (DE)

(73) Assignee: Airbus Defence and Space GmbH, Taufkirchen (DE)

(21) Appl. No.: 15/425,322

(22) Filed: Feb. 6, 2017

(30) Foreign Application Priority Data
Feb. 11, 2016 (DE) 10 2016 001 500.4

(51) Int. Cl. C22F 1/053; C22C 21/10; B33Y 80/00; B33Y 10/00; B33Y 70/00

(52) U.S. Cl. CPC C22F 1/053; B33Y 10/00; B33Y 70/00; B33Y 80/00; C22C 21/10

(57) ABSTRACT

An aluminum alloy, a method for producing a lightweight metal workpiece, a lightweight metal workpiece including the aluminum alloy, as well as the use of the aluminum alloy for producing high-strength lightweight metal workpieces by additive layer manufacturing (ALM) and/or spraying methods for load-optimized components, in particular in automobile manufacturing or in aviation and aerospace applications, plant engineering, medical technology, or as coating material for structural components are described herein.

### FIELD OF THE INVENTION

The present invention relates to an aluminum alloy, a method for producing a lightweight metal workpiece, a lightweight metal workpiece comprising the aluminum alloy, and also the use of the aluminum alloy to produce high-strength lightweight metal workpieces by means of additive layer manufacturing (ALM) and/or spraying methods for load optimized components especially in automobile manufacturing or in aviation and aerospace applications, plant engineering, medical technology, or as coating material for structural components.

### BACKGROUND OF THE INVENTION

Within the scope of ALM technology, there are different production methods, such as powder bed methods, powder jet methods, or wire-based processes. For heavily loaded structures/structural components, process technologies of this type provide a load-optimised component part construction with versatile individual design possibilities, for example by integrated and integral material construction from different or also “alloy-related” materials. The generative methods support maximum utilisation of materials alongside component part complexity, depending on the manufacturing method. Here, what is made possible inter alia is customised manufacture of near-end-contour structural components with potentially also local material adaptation/change/reinforcement integrated directly in the process, with integration of a number of, or at least two material powder containers or material wire guides.

ALM processes, particularly in air travel, constitute technological competition for precision casting techniques, which are used primarily for producing complex structural components for aviation or medical technology, which structural components are then thin-walled and load-optimised depending on the alloy. Also the small quantity of the required structural components is of great importance. In the case of precision casting the aluminum alloy A357(AlSi7Mg0.6) is primarily used for thin-walled structures, and A201/KO1 (AlCu5MgTiAg) is primarily used as a firmer variant for structural components having greater wall thicknesses. Standard materials are primarily used for ALM processes. In the case of titanium alloys the material is especially Ti6Al4V, and in the case of aluminum alloys it is AlSi10Mg. The nowadays required strength values are considerably above 400 MPa and are often only achievable with wrought alloys which, however, are not or only difficult to cast with common casting methods.

However, in order to be able to utilise the advantages of ALM process technology to the full extent depending on the application of the structural components, it is necessary to design process-optimised materials.

### BRIEF SUMMARY OF THE INVENTION

It is therefore desirable to provide an aluminum alloy. It is also desirable to provide an aluminum alloy which can be integrated directly in the production process in local or integral component part manufacture. It is additionally desirable to provide an aluminum alloy by means of which complex thermo-mechanical treatment can be avoided and therefore further costly and time-consuming process steps can be saved. It is also desirable to provide an aluminum alloy which enables a heat treatment without material damage and/or thermal stresses/warping. In addition, it is desirable to provide an aluminum alloy with which it is possible to dispense with complex component part levelling and with which the component part reproducibility and economic efficiency can also be increased. In particular, it is therefore desirable to provide an aluminum alloy which is suitable for producing lightweight metal workpieces, in particular by ALM process technologies and/or spraying methods.

An aspect of the present invention may provide an aluminum alloy, in particular an aluminum alloy which is suitable for producing high-strength lightweight metal workpieces. Another aspect of the present invention may enable the aluminum alloy to be directly integrated in the production process in local or integral component part manufacture. A further aspect of the present invention may avoid complex thermo-mechanical treatment (as for instance by rolling, extrusion and forging) and therefore further costly and time-consuming process steps can be saved by means of the aluminum alloy. A further aspect of the present invention may allow the aluminum alloy to undergo a heat treatment without material damage and/or thermal stresses/warping. A further aspect of the present invention may dispense with complex component part levelling and to also be able to increase the component part reproducibility and economic efficiency on account of the use of the aluminum alloy. A further aspect of the present invention may make the aluminum alloy suitable for producing high-strength lightweight metal workpieces, in particular by ALM process technologies and/or spraying methods.

### BRIEF SUMMARY OF THE INVENTION

Accordingly, a first subject of the present invention is an aluminum alloy consisting of

4.0 to 10.0% by weight, in relation to the total weight of the alloy, of zinc (Zn),
1.0 to 3.5% by weight, in relation to the total weight of the alloy, of magnesium (Mg),
0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V),
0 to <2.5% by weight, in relation to the total weight of the alloy, of copper (Cu),
0 to <0.4% by weight, in relation to the total weight of the alloy, of silicon (Si),
0 to <0.5% by weight, in relation to the total weight of the alloy, of iron (Fe),
0 to 0.5% by weight, in relation to the total weight of the alloy, of manganese (Mn),
0 to 0.3% by weight, in relation to the total weight of the alloy, of chromium (Cr),
0 to 0.2% by weight, in relation to the total weight of the alloy, of titanium (Ti),
0 to 1.25% by weight, in relation to the total weight of the alloy, of scandium (Sc),
the rest being aluminum with further impurities individually of at most 0.1% by weight in relation to the total weight of the alloy, and on the whole at most 0.5% by weight, in relation to the total weight of the alloy.

The aluminum alloy according to an embodiment of the invention is in particular thermally stable. A further advantage is that the aluminum alloy according to an embodiment of the invention can be integrated directly in the production process in local or integral component part manufacture. A further advantage is that complex thermo-mechanical treatment can be avoided and therefore further costly and time-consuming process steps can be saved by means of the aluminum alloy according to an embodiment of the invention. A further advantage is the fact that the aluminum alloy according to an embodiment of the invention enables a heat treatment without material damage and/or thermal stresses/warping. A further advantage is that it is possible to dispense with complex component part levelling and to also increase the component part reproducibility and economic efficiency on account of the use of the aluminum alloy according to an embodiment of the invention. A further advantage is in particular the fact that the aluminum alloy according to an embodiment of the invention is suitable for producing high-strength lightweight metal workpieces, in particular by ALM process technologies and/or spraying methods.

By way of example, the alloy contains 4.0 to 8.0% by weight, in particular 4.1 to 8.0% by weight, in relation to the total weight of the alloy, of zinc (Zn) and/or 1.1 to 3.0% by weight, in relation to the total weight of the alloy, of magnesium (Mg).

By way of example, the alloy contains 0.01 to 0.2% by weight, in particular 0.03 to 0.15% by weight, in relation to the total weight of the alloy, of titanium (Ti) and/or 0.02 to 0.75% by weight, in particular 0.05 to 0.7% by weight in relation to the total weight of the alloy, of scandium (Sc).

By way of example, the alloy contains 0.01 to 2.0% by weight, in particular 0.05 to 1.5% by weight, in relation to the total weight of the alloy, of copper (Cu) and/or 0.01 to 0.5% by weight, in particular 0.05 to 0.4% by weight, in relation to the total weight of the alloy, of manganese (Mn), and/or 0.01 to 0.2% by weight, in particular 0.02 to 0.15% by weight, in relation to the total weight of the alloy, of chromium (Cr).

By way of example, the alloy contains magnesium (Mg) in an amount such that the ratio by weight of zinc (Zn) to Magnesium (Mg) [wt(Zn)/wt(Mg)] is from 2:1 to 3:1.

By way of example, the alloy contains 0.001 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V).

By way of example, the amount of hafnium (Hf) and/or terbium (Tb) corresponds individually to at most ¼ of the amount of scandium (Sc).

By way of example, the alloy is provided in the form of a powder, in particular in the form of a powder comprising particles having an average particle size d₅₀ of ≦100 μm, preferably 20 to 70 μm.

The present invention also provides a method for producing a lightweight metal workpiece, said method comprising the following steps:

a) providing an aluminum alloy as defined herein,
b) producing a lightweight metal workpiece comprising the aluminum alloy from step a) by means of additive layer manufacturing (ALM) and/or spraying methods, and
c) cooling the lightweight metal workpiece obtained in step b) to ≦80° C. with a solidification rate that is ≦10,000,000 K/sec.

By way of example, the method comprises a further step d) of subjecting the lightweight metal workpiece from step c) to a heat treatment in a temperature range of from 80 to 500° C.

The present invention also relates to a lightweight metal workpiece comprising the aluminum alloy as defined herein.

The present invention also relates to the use of the aluminum alloy as defined herein for producing high-strength lightweight metal workpieces by means of additive layer manufacturing (ALM) and/or spraying methods. The present invention additionally relates to the use of the aluminum alloy, as defined herein, for structural components, in particular in automobile manufacturing or in aviation and aerospace applications, plant engineering, medical technology, or as coating material for structural components.

### DETAILED DESCRIPTION

The present invention relates to an aluminum alloy.

The aluminum alloy consists of

4.0 to 10.0% by weight, in relation to the total weight of the alloy, of zinc (Zn),
1.0 to 3.5% by weight, in relation to the total weight of the alloy, of magnesium (Mg),
0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V),
0 to <2.5% by weight, in relation to the total weight of the alloy, of copper (Cu),
0 to <0.4% by weight, in relation to the total weight of the alloy, of silicon (Si),
0 to <0.5% by weight, in relation to the total weight of the alloy, of iron (Fe),
0 to 0.5% by weight, in relation to the total weight of the alloy, of manganese (Mn),
0 to 0.3% by weight, in relation to the total weight of the alloy, of chromium (Cr),
0 to 0.2% by weight, in relation to the total weight of the alloy, of titanium (Ti),
0 to 1.25% by weight, in relation to the total weight of the alloy, of scandium (Sc),
the rest being aluminum with further impurities individually of at most 0.1% by weight in relation to the total weight of the alloy, and on the whole at most 0.5% by weight, in relation to the total weight of the alloy.

The aluminum alloy should in particular be suitable for producing high-strength lightweight metal workpieces, by ALM process technologies and/or spraying methods.

One aspect of the present invention is therefore that the aluminum alloy contains zinc (Zn) in an amount of from 4.0 to 10.0% by weight, in relation to the total weight of the alloy. The aluminum alloy preferably contains zinc (Zn) in an amount of from 4.0 to 8.0% by weight, in particular from 4.1 to 8.0% by weight, in relation to the total weight of the alloy.

A further aspect of the present invention is that the aluminum alloy contains magnesium (Mg) in an amount of from 1.0 to 3.5% by weight, in relation to the total weight of the alloy. The aluminum alloy preferably contains magnesium (Mg) in an amount of from 1.1 to 3.0% by weight, in relation to the total weight of the alloy.

By way of example, the aluminum alloy contains zinc (Zn) in an amount of from 4.0 to 10.0% by weight and magnesium (Mg) in an amount of from 1.0 to 3.5% by weight, in relation to the total weight of the alloy. The aluminum alloy preferably contains zinc (Zn) in an amount of from 4.0 to 8.0% by weight and magnesium (Mg) in an amount of from 1.1 to 3.0% by weight, in relation to the total weight of the alloy. The aluminum alloy even more preferably contains zinc (Zn) in an amount of from 4.1 to 8.0% by weight and magnesium (Mg) in an amount of from 1.1 to 3.0% by weight, in relation to the total weight of the alloy.

One advantage of the present invention is that the aluminum alloy contains high amounts of zinc (Zn) in comparison to magnesium (Mg), and in particular the zinc amounts are higher than in conventional aluminum alloys.

The alloy contains zinc (Zn) and magnesium (Mg) preferably in an amount such that the ratio by weight of zinc (Zn) to Magnesium (Mg) [wt(Zn)/wt(Mg)] is from 2:1 to 3:1. This ratio by weight of zinc (Zn) to Magnesium (Mg) is in particular advantageous for improving the corrosion resistance.

The aluminum alloy can further contain various additional alloy elements.

In addition, at least one element selected from the group consisting of zirconium (Zr), hafnium (Hf), molybdenum (Mo), terbium (Tb), niobium (Nb), gadolinium (Gd), erbium (Er), and vanadium (V) can be added to the aluminum alloy. In particular, 0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V) can be added to the aluminum alloy.

In one embodiment, the aluminum alloy contains 0.001 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V). By way of example, the aluminum alloy contains 0.001 to 0.5% by weight, in relation to the total weight of the alloy, of at least one element selected from the group consisting of zirconium (Zr), hafnium (Hf), terbium (Tb), and vanadium (V).

In one embodiment, the aluminum alloy contains 0.001 to 0.5% by weight, in relation to the total weight of the alloy, of zirconium (Zr) and/or vanadium (V). By way of example, the aluminum alloy contains 0.001 to 0.5% by weight, in relation to the total weight of the alloy, of zirconium (Zr) and vanadium (V). Alternatively, the aluminum alloy contains 0.001 to 0.5% by weight, in relation to the total weight of the alloy, of zirconium (Zr) or vanadium (V).

By way of example, the aluminum alloy contains at least two elements, in particular two elements, selected from the group consisting of zirconium (Zr), hafnium (Hf), molybdenum (Mo), terbium (Tb), niobium (Nb), gadolinium (Gd), erbium (Er), and vanadium (V) individually in an amount of 0.001 to 0.5% by weight, in relation to the total weight of the alloy. Alternatively, the aluminum alloy contains at least three elements, in particular three or four elements, selected from the group consisting of zirconium (Zr), hafnium (Hf), molybdenum (Mo), terbium (Tb), niobium (Nb), gadolinium (Gd), erbium (Er), and vanadium (V) individually in an amount of 0.001 to 0.5% by weight, in relation to the total weight of the alloy.

If the aluminum alloy contains zirconium (Zr) the amount of zirconium (Zr) corresponds to at most ¼ of the amount of scandium (Sc). In other words, the aluminum alloy contains zirconium (Zr) in an amount that corresponds to ≦25% of the amount of scandium (Sc). By way of example, the aluminum alloy contains zirconium (Zr) in an amount that corresponds to <25% of the amount of scandium (Sc).

Preferably, the aluminum alloy contains zirconium (Zr), by way of example in an amount of from 0.01 to 0.375% by weight, in relation to the total weight of the alloy. Preferably, the aluminum alloy contains zirconium (Zr) in an amount of from 0.02 to 0.35% by weight, in particular 0.05 to 0.3% by weight, in relation to the total weight of the alloy.

In an alternative embodiment, the aluminum alloy contains 0 to 0.5% by weight, in relation to the total weight of the alloy, of hafnium (Hf) and/or terbium (Tb). In one embodiment the aluminum alloy contains 0.001 to 0.5% by weight (in total), in relation to the total weight of the alloy, of hafnium (Hf) and terbium (Tb). Alternatively, the aluminum alloy contains 0.001 to 0.5% by weight, in relation to the total weight of the alloy, of hafnium (Hf) or terbium (Tb).

If the aluminum alloy contains hafnium (Hf) and/or terbium (Tb), the amount of hafnium (Hf) and/or terbium (Tb) corresponds individually to at most ¼ of the amount of scandium (Sc). In other words, the aluminum alloy contains hafnium (Hf) and/or terbium (Tb) individually in an amount that corresponds to ≦25% of the amount of scandium (Sc). By way of example, the aluminum alloy contains hafnium (Hf) and/or terbium (Tb) individually in an amount that corresponds to <25% of the amount of scandium (Sc).

In one embodiment the aluminum alloy contains 0.001 to 0.5% by weight of zirconium (Zr) or 0.001 to 0.5% by weight of vanadium (V) or 0.001 to 0.5% by weight of gadolinium (Gd) or 0.001 to 0.5% by weight of hafnium (Hf) or 0.001 to 0.5% by weight of molybdenum (Mo) or 0.001 to 0.5% by weight of terbium (Tb) or 0.001 to 0.5% by weight of niobium (Nb) or 0.001 to 0.5% by weight of erbium (Er). Alternatively, the aluminum alloy contains 0.001 to 0.5% by weight of zirconium (Zr) and 0.001 to 0.5% by weight of vanadium (V) and 0.001 to 0.5% by weight of gadolinium (Gd) and 0.001 to 0.5% by weight of hafnium (Hf) and 0.001 to 0.5% by weight of molybdenum (Mo) and 0.001 to 0.05% by weight of terbium (Tb) and 0.001 to 0.5% by weight of niobium (Nb) and 0.001 to 0.5% by weight of erbium (Er). The values in % by weight relate in each case to the total weight of the alloy.

The aluminum alloy contains titanium (Ti) in an amount of from 0 to 0.2% by weight, in relation to the total weight of the alloy. The aluminum alloy preferably contains titanium (Ti) in an amount of from 0.01 to 0.2% by weight, in particular 0.03 to 0.15% by weight, in relation to the total weight of the alloy. In particular, titanium reduces the electrical conductivity.

The aluminum alloy also contains scandium (Sc) in an amount of from 0 to 1.25% by weight, in relation to the total weight of the alloy. The aluminum alloy preferably contains scandium (Sc) in an amount of from 0.02 to 0.75% by weight, in particular 0.05 to 0.7% by weight, in relation to the total weight of the alloy.

The aluminum alloy also contains copper (Cu) in an amount of from 0 to <2.5% by weight, in relation to the total weight of the alloy. The aluminum alloy preferably contains copper (Cu) in an amount of from 0.01 to 2.0% by weight, in particular 0.05 to 1.5% by weight, in relation to the total weight of the alloy.

The aluminum alloy also contains manganese (Mn) in an amount of from 0 to 0.5% by weight, in relation to the total weight of the alloy. The aluminum alloy preferably contains manganese (Mn) in an amount of from 0.01 to 0.5% by weight, in particular 0.05 to 0.4% by weight, in relation to the total weight of the alloy.

The aluminum alloy also contains iron (Fe) in an amount of from 0 to <0.5% by weight, in relation to the total weight of the alloy. The aluminum alloy preferably contains iron (Fe) in an amount of from 0.05 to 0.4% by weight, in particular 0.05 to 0.2% by weight, in relation to the total weight of the alloy.

The aluminum alloy also contains chromium (Cr) in an amount of from 0 to 0.3% by weight, in relation to the total weight of the alloy. The aluminum alloy preferably contains chromium (Cr) in an amount of from 0.01 to 0.2% by weight, in particular 0.02 to 0.15% by weight, in relation to the total weight of the alloy.

The aluminum alloy also contains silicon (Si) in an amount of from 0 to <0.4% by weight, in relation to the total weight of the alloy. The aluminum alloy preferably contains silicon (Si) in an amount of from 0.01 to 0.2% by weight, in particular 0.05 to 0.15% by weight, in relation to the total weight of the alloy.

In one embodiment the aluminum alloy preferably contains iron (Fe) in an amount of from 0.05 to 0.4% by weight, preferably 0.05 to 0.2% by weight, in relation to the total weight of the alloy, and silicon (Si) in an amount of from 0.01 to 0.2% by weight, in particular 0.05 to 0.15% by weight, in relation to the total weight of the alloy.

The rest of the aluminum alloy is aluminum. The aluminum alloy can also contain impurities, individually of at most 0.1% by weight in relation to the total weight of the alloy, and on the whole at most 0.5% by weight, in relation to the total weight of the alloy.

The aluminum alloy therefore preferably consists of

4.0 to 8.0% by weight, preferably 4.1 to 8.0% by weight, in relation to the total weight of the alloy, of zinc (Zn),
1.1 to 3.0% by weight, in relation to the total weight of the alloy, of magnesium (Mg), 0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V),
0 to <2.5% by weight, in relation to the total weight of the alloy, of copper (Cu),
0 to <0.4% by weight, in relation to the total weight of the alloy, of silicon (Si),
0 to <0.5% by weight, in relation to the total weight of the alloy, of iron (Fe),
0 to 0.5% by weight, in relation to the total weight of the alloy, of manganese (Mn),
0 to 0.3% by weight, in relation to the total weight of the alloy, of chromium (Cr),
0 to 0.2% by weight, in relation to the total weight of the alloy, of titanium (Ti),
0 to 1.25% by weight, in relation to the total weight of the alloy, of scandium (Sc),
the rest being aluminum with further impurities individually of at most 0.1% by weight in relation to the total weight of the alloy, and on the whole at most 0.5% by weight, in relation to the total weight of the alloy.

The aluminum alloy therefore preferably consists of

4.0 to 8.0% by weight, preferably 4.1 to 8.0% by weight, in relation to the total weight of the alloy, of zinc (Zn),
1.1 to 3.0% by weight, in relation to the total weight of the alloy, of magnesium (Mg),
0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V),
0 to <2.5% by weight, in relation to the total weight of the alloy, of copper (Cu),
0.01 to 0.2% by weight, in relation to the total weight of the alloy, of silicon (Si),
0.05 to 0.4% by weight, in relation to the total weight of the alloy, of iron (Fe),
0 to 0.5% by weight, in relation to the total weight of the alloy, of manganese(Mn),
0 to 0.3% by weight, in relation to the total weight of the alloy, of chromium (Cr),
0 to 0.2% by weight, in relation to the total weight of the alloy, of titanium (Ti),
0 to 1.25% by weight, in relation to the total weight of the alloy, of scandium (Sc),
the rest being aluminum with further impurities individually of at most 0.1% by weight in relation to the total weight of the alloy, and on the whole at most 0.5% by weight, in relation to the total weight of the alloy.

The aluminum alloy can be provided in the form of a powder or wire. Methods for producing alloys in the form of a powder or wire are known in the prior art.

The aluminum alloy according to an embodiment of the invention is suitable in particular for producing lightweight metal workpieces, in particular high-strength lightweight metal workpieces, by ALM process technologies and/or spraying methods. The aluminum alloy according to an embodiment of the invention is therefore preferably provided in the form of a powder, wire or filler material.

By way of example, the aluminum alloy is provided in the form of a powder comprising particles having an average particle size d₅₀ of ≦100 μm, preferably 10 to 70 μm.

In one embodiment, the aluminum alloy is provided in the form of a powder comprising particles having an average particle size d₅₀ of from 20 to 70 μm, preferably from 20 μm to 60 μm. Alternatively, the aluminum alloy is provided in the form of a wire having an average wire diameter of from 0.8 mm to 5 mm, preferably from 0.8 mm to 1.2 mm.

The aluminum alloy is preferably used as a powder when the aluminum alloy is to be processed by means of spraying methods. Spraying methods are known in the prior art. By way of example, the lightweight metal workpiece can be produced via cold gas, atmospheric plasma, HVOF or flame spraying. The average particle size d₅₀ of the powder is preferably ≦100 μm, even more preferably from 50 to 90 μm, when the lightweight metal workpiece is produced via atmospheric plasma, HVOF or flame spraying. If the lightweight metal workpiece is produced via cold gas, the powder has an average particle size d₅₀ of from 5 to 70 μm, preferably 5 to 60 μm.

The aluminum alloy according to an embodiment of the invention is therefore also suitable for producing high-strength lightweight metal workpieces by spraying methods. The aluminum alloy according to an embodiment of the invention is preferably provided in the form of a powder or wire.

In one embodiment a wire or a filler material is firstly produced from the powder of the aluminum alloy. Such production methods are known in the prior art.

The present invention also relates to a method for producing a lightweight metal workpiece, in particular a high-strength lightweight metal workpiece, by means of additive layer manufacturing (ALM). The lightweight metal workpiece is preferably produced by a method as described hereinafter.

The method according to an aspect of the invention for producing the lightweight metal workpiece, in particular the high-strength lightweight metal workpiece, comprises at least the following steps

a) providing an aluminum alloy,
b) producing a lightweight metal workpiece comprising the aluminum alloy from step a) by means of additive layer manufacturing (ALM), and
c) cooling the lightweight metal workpiece obtained in step b) to ≦80° C. with a solidification rate that is ≦10,000,000 K/sec.

By way of example, the method for producing the lightweight metal workpiece, in particular the high-strength lightweight metal workpiece, comprises a further step d) of subjecting the lightweight metal workpiece from step c) to a heat treatment in a temperature range of from 80 to 500° C.

In one embodiment the method for producing the lightweight metal workpiece, in particular the high-strength lightweight metal workpiece, consists of the following steps:

a) providing an aluminum alloy,
b) producing a lightweight metal workpiece comprising the aluminum alloy from step a) by means of additive layer manufacturing (ALM),
c) cooling the lightweight metal workpiece obtained in step b) to ≦80° C. with a solidification rate that is ≦10,000,000 K/sec, and
d) optionally subjecting the lightweight metal workpiece from step c) to a heat treatment in a temperature range of from 80 to 500° C.

According to step a), one aspect of the method according to the invention is therefore that an aluminum alloy is provided.

With regard to the aluminum alloys, reference is made to the above definitions in respect of the aluminum alloy and embodiments thereof.

According to step b) of the method according to an aspect of the invention, a lightweight metal workpiece comprising the aluminum alloy is produced by means of additive layer manufacturing (ALM).

Methods for producing lightweight metal workpieces by means of additive layer manufacturing (ALM) are known in the prior art.

According to step c) of the method according to an aspect of the invention, the lightweight metal workpiece obtained in step b) is cooled to ≦80° C. with a solidification rate that is ≦10,000,000 K/sec.

By way of example, the cooling in step c) is performed to ≦60° C., preferably to room temperature.

It is known to a person skilled in the art that the solidification rate should be adapted to the diameter of the produced lightweight metal component part/workpiece and is dependent on the heat dissipation of the produced lightweight metal workpiece. A person skilled in the art will therefore adapt the solidification rate to the produced lightweight metal workpiece accordingly, insofar as possible. In one embodiment of the present invention, the cooling in step c) is performed with a solidification rate which is 1,000 to 10,000,000 K/sec, and preferably 5,000 to 100,000 K/sec. By way of example, the cooling in step c) is performed with a solidification step which is 10,000 to 100,000 K/sec, preferably 25,000 to 100,000 K/sec, most preferably 50,000 to 100,000 K/sec. Such a solidification rate in particular has the advantage that higher amounts of scandium can be added to the aluminum alloy.

Such methods for cooling lightweight metal workpieces are known in the prior art. By way of example, the lightweight metal workpiece can be cooled in a defined manner with the aid of cooling in moving air or by quenching in water.

Alternatively, the cooling in step c) is performed in the open air.

In an optional step d) of the method according to an aspect of the invention, the lightweight metal workpiece obtained in step c) can be subjected to a heat treatment in a temperature range of from 80 to 500° C.

The heat treatment according to optional step d) of the method according to an aspect of the invention can also be performed in a number of stages and/or steps.

The lightweight metal workpiece obtained in step c) is preferably subjected to a heat treatment in a temperature range of from 80 to 470° C.

In one embodiment of the present invention, the heat treatment according to optional step d) is performed in a two-stage process. By way of example, the first step of the heat treatment can be performed in a temperature range of from 100 to 500° C., for example in a temperature range from 100 to 470° C., for a period of from 10 min to 2 h and the second step of the heat treatment can be performed in a temperature range of from 80 to 160° C. for a period of from 10 min to 50 h.

By way of example, the heat treatment can be performed in air, shielding gas, or in a vacuum. By way of example, the heat treatment according to optional step d) of the method according to the invention is performed in shielding gas, such as nitrogen or argon, at temperatures between 80 and 500° C., for example at temperatures between 80 and 470° C., for a period of from 10 min to 52 h.

In one embodiment of the present invention, the heat treatment according to optional step d) of the method according to the invention is performed directly after step c), i.e. the heat treatment according to step d) of the method according to the invention is carried out directly with the lightweight metal workpiece obtained in step c). In other words, if a heat treatment according to step d) is carried out, the method according to the invention is preferably carried out without one or more further method steps between the method steps c) and d). Alternatively, the optional heat treatment according to step d) of the method according to the invention is performed after step c), but at a later moment in time, i.e. the heat treatment according to step d) of the method according to the invention is carried out with the lightweight metal workpiece obtained in step c), but not immediately after step c). In other words, the method according to the invention is carried out without one or more further method steps between the method steps c) and d).

In one embodiment of the present invention, the heat-treated lightweight metal workpiece obtained in step d) can be subjected to a further cooling.

By way of example, the heat-treated lightweight metal workpiece obtained in step d) is cooled to room temperature. In one embodiment, the heat-treated lightweight metal workpiece obtained in step d) is cooled to room temperature in one step. Alternatively, the heat-treated lightweight metal workpiece obtained in step d) is cooled to room temperature in a number of steps. By way of example, the heat-treated lightweight metal workpiece obtained in step d) is cooled to a defined temperature below the heat treatment temperature in step d), followed by a cooling in the open air to room temperature.

In one embodiment of the present invention, the heat-treated lightweight metal workpiece obtained in step d) is cooled to room temperature with a cooling rate which is ≧10 K/sec, and preferably ≧10 to 20 K/sec. By way of example, the heat-treated lightweight metal workpiece is cooled to room temperature with a cooling rate in a range of ≧20 K/sec or in a range from 20 K/sec to 1000 K/sec.

Such methods for cooling heat-treated lightweight metal workpieces are known in the prior art. By way of example, the heat-treated lightweight metal workpiece can be cooled in a defined manner to room temperature with the aid of cooling in moving air or by quenching in water

Alternatively, the heat-treated lightweight metal workpiece obtained in step d) is cooled to room temperature in the open air.

The present invention also relates to a method for producing a lightweight metal workpiece, in particular a high-strength lightweight metal workpiece, by means of spraying methods. The lightweight metal workpiece is preferably produced by a method as described hereinafter.

The method according to an aspect of the invention for producing the lightweight metal workpiece, in particular the high-strength lightweight metal workpiece, comprises at least the following steps:

a) providing an aluminum alloy,
b) producing a lightweight metal workpiece comprising the aluminum alloy from step a) by means of spraying methods, and
c) cooling the lightweight metal workpiece obtained in step b) to ≦80° C. with a solidification rate that is ≦10,000,000 K/sec.

By way of example, the method for producing the lightweight metal workpiece comprises a further step d) of subjecting the lightweight metal workpiece from step c) to a heat treatment in a temperature range of from 80 to 500° C.

In one embodiment the method for producing the lightweight metal workpiece, in particular the high-strength lightweight metal workpiece, consists of the following steps:

a) providing an aluminum alloy,
b) producing a lightweight metal workpiece comprising the aluminum alloy from step a) by means of spraying methods,
c) cooling the lightweight metal workpiece obtained in step b) to ≦80° C. with a solidification rate that is ≦10,000,000 K/sec, and
d) optionally subjecting the lightweight metal workpiece from step c) to a heat treatment in a temperature range of from 80 to 500° C.

With regard to steps a), b), c) and optional step d), reference is made to the above definitions in respect of the aluminum alloy, the method for producing a lightweight metal workpiece by means of additive layer manufacturing, and embodiments thereof.

Methods for producing lightweight metal workpieces by means of spraying methods are known in the prior art. By way of example, the lightweight metal workpiece can be produced via cold gas, atmospheric plasma, HVOF, and flame spraying.

On account of the advantages provided by the lightweight metal workpiece according to an embodiment of the invention, the present invention also relates to a lightweight metal workpiece, in particular a high-strength lightweight metal workpiece, comprising the aluminum alloy. By way of example, the lightweight metal workpiece, in particular the high-strength lightweight metal workpiece, consists of the aluminum alloy.

The present invention is also directed to the use of the aluminum alloy for producing high-strength lightweight metal workpieces by means of additive layer manufacturing (ALM) and/or spraying methods.

A further aspect of the present invention also relates to the use of the aluminum alloy for structural components, in particular in automobile manufacturing or in aviation and aerospace applications, plant engineering, medical technology, or as coating material for structural components.

As mentioned above, the aluminum alloy according to an embodiment of the invention offers the advantage that it can be integrated directly in the production process in local or integral component part manufacture. A further advantage is the fact that complex thermo-mechanical treatments can be avoided by means of the aluminum alloy according to an embodiment of the invention, and therefore further costly and time-consuming process steps can be saved. A further advantage is the fact that the aluminum alloy according to an embodiment of the invention enables a heat treatment without material damage and/or thermal stresses/warping. A further advantage is the fact that, on account of the use of the aluminum alloy according to an embodiment of the invention, it is possible to dispense with complex component part levelling and also to increase the component part reproducibility and economic efficiency. A further advantage is in particular the fact that the aluminum alloy according to an embodiment of the invention is suitable for producing high-strength lightweight metal workpieces, in particular by ALM process technologies and/or spraying methods.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aluminum alloy consisting of:
4.0 to 10.0% by weight, in relation to the total weight of the alloy, of zinc (Zn);
1.0 to 3.5% by weight, in relation to the total weight of the alloy, of magnesium (Mg);
0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V);
0 to <2.5% by weight, in relation to the total weight of the alloy, of copper (Cu);
0 to <0.4% by weight, in relation to the total weight of the alloy, of silicon (Si);
0 to <0.5% by weight, in relation to the total weight of the alloy, of iron (Fe);
0 to 0.5% by weight, in relation to the total weight of the alloy, of manganese (Mn);
0 to 0.3% by weight, in relation to the total weight of the alloy, of chromium (Cr);
0 to 0.2% by weight, in relation to the total weight of the alloy, of titanium (Ti);
0 to 1.25% by weight, in relation to the total weight of the alloy, of scandium (Sc);
the rest being aluminum with further impurities individually of at most 0.1% by weight in relation to the total weight of the alloy, and on the whole at most 0.5% by weight, in relation to the total weight of the alloy.

2. The aluminum alloy according to claim 1, wherein the alloy contains at least one of:
4.0 to 8.0% by weight, in relation to the total weight of the alloy, of zinc (Zn); and
1.1 to 3.0% by weight, in relation to the total weight of the alloy, of magnesium (Mg).

3. The aluminum alloy according to claim 1, wherein the alloy contains at least one of:
0.01 to 0.2% by weight, in relation to the total weight of the alloy, of titanium (Ti); and
0.02 to 0.75% by weight, in relation to the total weight of the alloy, of scandium (Sc).

4. The aluminum alloy according to claim 1, wherein the alloy contains at least one of:
0.01 to 2.0% by weight, in relation to the total weight of the alloy, of copper (Cu);
0.01 to 0.5% by weight, in relation to the total weight of the alloy, of manganese (Mn); and
0.01 to 0.2% by weight, in relation to the total weight of the alloy, of chromium (Cr).

5. The aluminum alloy according to claim 1 wherein the alloy contains magnesium (Mg) in an amount such that the ratio by weight of zinc (Zn) to Magnesium (Mg) [wt(Zn)/wt(Mg)] is from 2:1 to 3:1.

6. The aluminum alloy according to any claim 1, wherein the alloy contains 0.001 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V).

7. The aluminum alloy according to claim 1, wherein the amount of at least one of hafnium (Hf) and terbium (Tb) corresponds individually to at most ¼ of the amount of scandium (Sc).

8. The aluminum alloy according to claim 1, wherein the alloy is provided in the form of a powder comprising particles having an average particle size d₅₀ of ≦100 μm.

9. The aluminum alloy according to claim 8, wherein the alloy is provided in the form of a powder comprising particle having an average particle size d₅₀ of ≦20 to 70 μm.

10. A method for producing a lightweight metal workpiece, said method comprising:
a) providing an aluminum alloy according to claim 1;
b) producing a lightweight metal workpiece comprising the aluminum alloy from step a) by at least one of additive layer manufacturing (ALM) and spraying methods;
c) cooling the lightweight metal workpiece obtained in step b) to ≦80° C. with a solidification rate that is ≦10,000,000 K/sec.

11. The method according to claim 10, wherein the method comprises a further step d) of subjecting the lightweight metal workpiece from step c) to a heat treatment in a temperature range of from 80 to 500° C.

12. A lightweight metal workpiece comprising an aluminum alloy consisting of:
4.0 to 10.0% by weight, in relation to the total weight of the alloy, of zinc (Zn);
1.0 to 3.5% by weight, in relation to the total weight of the alloy, of magnesium (Mg);
0 to 0.5% by weight, in relation to the total weight of the alloy, of at least one element selected from the group consisting of zirconium (Zr), hafnium (Hf), molybdenum (Mo), terbium (Tb), niobium (Nb), gadolinium (Gd), erbium (Er), and vanadium (V);
0 to <2.5% by weight, in relation to the total weight of the alloy, of copper (Cu);
0 to <0.4% by weight, in relation to the total weight of the alloy, of silicon (Si);
0 to <0.5% by weight, in relation to the total weight of the alloy, of iron (Fe);
0 to 0.5% by weight, in relation to the total weight of the alloy, of manganese (Mn);
0 to 0.3% by weight, in relation to the total weight of the alloy, of chromium (Cr);
0 to 0.2% by weight, in relation to the total weight of the alloy, of titanium (Ti);
0 to 1.25% by weight, in relation to the total weight of the alloy, of scandium (Sc);
the rest being aluminum with further impurities individually of at most 0.1% by weight in relation to the total weight of the alloy, and on the whole at most 0.5% by weight, in relation to the total weight of the alloy.
